(19) United States
(12) Patent Application Publication
(10) Pub. No.: US 2022/0041371 A1
(43) Pub. Date: Feb. 10, 2022

(54) FLEXIBLE CONTAINER FOR PACKAGING WASTE

(71) Applicant: LINERBENNE, Nantes (FR)

(72) Inventor: Franck Milhem, Noisy Le Grand (FR)

(21) Appl. No.: 17/281,418

(22) PCT Filed: Oct. 1, 2019
(86) PCT No.: PCT/EP2019/076646

§ 371 Date: Mar. 30, 2021

(30) Foreign Application Priority Data
Oct. 5, 2018 (FR) 1859257

(51) Int. Cl. B65F 1/00; B65F 1/06; B65F 1/14

(52) U.S. Cl. CPC B65F 1/002; B65F 2240/118; B65F 1/1426; B65F 1/06

(57) ABSTRACT

A flexible container for packaging waste, including an outer casing forming the outer surface of the container and having, in a top part, an opening that can be opened or closed, an inner casing delimiting an Inner space of the container for receiving and accommodating the waste, disposed inside the outer casing, the inner casing including, in a top part, an opening that can be opened or closed by means of a closure system attached to the inner casing, and at least one reinforcing strip superposed at least partially on and attached to the closure system and to the inner casing.

### FIELD OF THE INVENTION

The present invention concerns the field of packaging waste. The term “waste” is employed in the sense of European directive 2006/12/EC of 5 Apr. 2006 and designates any substance or any object which the holder disposes of or intends or is required to dispose of falling within the categories listed in Appendix I of that directive.

It more particularly concerns the packaging of waste resulting from removal of asbestos in construction or public works.

It therefore relates to a container, in particular a flexible container, for packaging waste and to a method of packaging waste by means of this kind of container.

### Prior Art and Objectives of the Invention

In the context of packaging waste, in particular asbestos, there is known the patent application EP 3 133 033 relating to flexible packaging for solid waste with a capacity greater than 5 m³, consisting of a mechanically strong outer casing and a dustproof inner casing, each comprising a lid closable over a pocket by closure means in such a manner as to close the packaging in a sealed manner by means of a system of flaps extending from the upper peripheral edge of the packaging, disposed between the outer casing and the inner casing and covering the closure means of the inner casing.

This kind of packaging is well suited to homogeneous waste of milling waste, polluted soil and steelworks dust type with a small particle size range.

In the field of the invention, it is essential to be able to guarantee that the waste container is sealed when loading waste on a collection site, during transportation and when offloading at a storage site, whilst controlling manufacturing costs.

Flexible containers for packaging waste are disposed in a metal skip when they are loaded and transported. Some skips can be offloaded from the transporter truck at the storage site, in particular by means of an articulated arm of Ampliroll® type, necessitating a small inclination during tipping, which makes it possible to preserve the integrity and therefore the seal of the container.

However, the 32T capacity metal skip accommodating the flexible container remains fixed to the transporter truck and the skip is tilted to offload the flexible container with the waste. In the latter case, the tilt angle is large, in other words the inclination of the skip during tipping is large, which leads to sudden offloading and greatly increases the risk of damaging the flexible container.

Reinforcing some parts of the casings of the container and/or increasing the thickness of the casings of the container at least in certain locations has been envisaged. Such solutions may be employed but are not totally satisfactory and moreover increase the cost of the containers.

Another problem in the management of waste, in particular waste containing asbestos, arises on site. The waste is often formed of scrap metal and large blocks or soil mixed with other materials of stone, concrete block, fibrocement pipe fragments type, which increases the risk of tearing or piercing the containers and eventually of destroying the seal thereof. It is therefore necessary, before packaging the waste in the containers, to screen it to sort it and/or to break up waste that is too bulky into smaller fragments, which generates high processing costs.

Thus there exists a need to benefit from flexible containers for packaging and transporting waste from a collection site to a storage site in a strong and sealed manner, in particular asbestos waste or other waste, in particular waste consisting of large blocks and scrap metal, without necessitating screening and/or reduction of the size of the waste by breaking it up before packaging it.

### SUMMARY OF THE INVENTION

The present invention succeeds in addressing some or all of that need and concerns a flexible container for packaging waste, including:
an outer casing forming the outer surface of the container and having, in a top part, an opening that can be opened or closed,
an inner casing delimiting an inner space of the container for receiving and accommodating the waste, disposed inside the outer casing, the inner casing including, in a top part, an opening that can be opened or closed by means of a closure system attached to the inner casing, and
at least one reinforcing strip superposed at least partially on and attached to the closure system and to the inner casing.

Thanks to the invention, a strong container is available. In particular, the presence of the reinforcing strip or strips enables the container to be reinforced at the location of the attachment between closure system and inner casing and mechanical strength, force at rupture and elongation to be increased.

Said at least one reinforcing strip is preferably interleaved between the closure system and the inner casing. This kind of stacking can make it possible to increase significantly the strength of the container in this zone.

Alternatively or additionally, the container may include least one reinforcing strip disposed under the inner casing.

The opening of the inner casing may have at least one edge. In this case, the container may include at least one reinforcing strip on each side of said at least one edge of the opening.

The closure system preferably includes a zip closure. The zip closure is advantageously made with a zip sewn to each side of a woven strip made of polyester, for example approximately 3 cm on a side.

The closure system may be sewn to the inner casing. In this case, the same stitching can serve both for attaching the closure system and the reinforcing strip or strips. A plurality of for example parallel rows of stitches can make it possible to attach the closure system and the reinforcing strip or strips simultaneously.

The closure system of the inner casing is preferably fixed to an upper wall of the inner casing.

Said at least one reinforcing strip may include a composite material with reinforcing fibers comprising fibers chosen in the group consisting of glass fibers, carbon fibers, aramide fibers, natural fibers and mixtures thereof, preferably glass fibers. The fibrous reinforcement is for example woven. Said at least one reinforcing strip may include at least one polymer chosen in the group consisting of a polyolefin, polyethylene terephthalate (PET), polyester, preferably PET.

Said at least one reinforcing strip may be coated on one or both sides with an adhesive, for example a synthetic rubber resin. The presence of the adhesive can make it possible to improve the retention of the strip against the closure system and/or the inner casing before attachment, in particular by sewing.

The thickness of the reinforcing strip may be between 0.10 mm and 0.20 mm inclusive, preferably between 0.14 mm and 0.18 mm inclusive, for example equal to 0.16 mm.

The tensile strength of the reinforcing strip may be approximately 550 N/inch.

The outer casing may include a closure system that may comprise a zip. The closure system of the outer casing may be present on an upper wall of the outer casing. In the latter case, and where the inner casing also includes a zip, the zips of the inner casing and of the outer casing have for example oppositely oriented U-shaped profiles.

The container may include at least one flap interleaved between the outer casing and the inner casing. The container may then include at least one first attachment zone and one second attachment zone disposed on respective opposite sides of the closure system, the flap or flaps being attached to the inner casing in at least the first attachment zone, the flap or flaps and/or the inner casing being provided with attachment means to be able to attach the flap or flaps to the inner casing, in the second attachment zone, after closing the inner casing. Because the flap or flaps is/are attached on either side of the closure system, it/they cover the latter, improving the seal of the inner casing at the level of the closure system.

The inner casing advantageously includes an upper wall, a lower wall and at least one lateral wall connecting the upper wall and the lower wall.

In one particular embodiment the flap or flaps cover(s) only the upper wall of the inner casing. In this case, the first and second attachment zones are on the upper wall, the first or second attachment zones being for example at the junction between upper wall and said at least one lateral wall.

In another embodiment, the flap or flaps cover(s) at least partly the lateral wall or walls and the first or second attachment zone is situated in a lower part of the inner casing.

In this case, the first attachment zone is for example situated in the lower part of the inner casing. The flap or flaps is/are preferably welded to the inner casing in this first attachment zone. Alternatively, they may be adhesively bonded, for example by means of a double-sided adhesive tape.

The second attachment zone may be on the upper wall of the inner casing, the attachment means in this second attachment zone in particular including an adhesive, preferably a double-sided adhesive tape. The attachment means may be mounted on the flap or flaps along at least one edge of the latter.

The first attachment zone may be situated in a lower portion of said at least one lateral wall, in particular at the junction between said at least one lateral wall and the lower wall, the flap or flaps then covering the total height of the lateral wall or walls. In this case the container has over its entire height a triple layer formed by the outer casing, the inner casing and the flap or flaps. This makes it possible to increase the lateral strength of the container.

The container may include a third attachment zone for the attachment between said at least one flap and the inner casing, the third attachment zone being on said at least one lateral wall, in particular in a central portion of the inner casing. The attachment in this third attachment zone is effected for example by means of an adhesive, for example at least one double-sided adhesive tape mounted on the flap and/or the inner casing.

The container may further include a fourth attachment zone for the attachment between said at least one flap and the inner casing, the fourth attachment zone being on said at least one lateral wall in an upper part of the inner casing. The attachment in this fourth attachment zone is effected for example by means of an adhesive, for example at least one double-sided adhesive tape mounted on the flap and/or the inner casing.

The presence of a third attachment zone and where applicable a fourth attachment zone makes it possible to strengthen the container, facilitating loading thereof. Other attachment zones may be added without departing from the scope of the invention.

In one embodiment the inner casing has a substantially parallelepipedal shape, the inner casing including four lateral walls, the container including four flaps covering the lateral walls at least partly, preferably completely.

By “upper part” is meant a part situated above half the total height of the container or of the casing. By “lower part” is meant a part situated below half the total height of the container or of the casing.

References to an “upper” or “lower” part or wall or element are for a visitor observing the container when the latter is placed on the ground in its position for loading waste.

The outer casing may have a substantially parallelepipedal shape, the outer casing including an upper wall, a lower wall interconnected by four lateral walls.

The flap or flaps may not cover the lower wall of the inner casing.

The flap or flaps may feature a fold to cover a junction between the upper wall and the lateral wall or walls of the inner casing, that junction forming the periphery of the upper wall of the inner casing.

At least one flap may be attached to the outer casing in at least one attachment zone, in particular in two attachment zones, in particular by means of an adhesive, for example by means of least one double-sided adhesive tape, which may be mounted on the flap or flaps and/or the outer casing. This kind of attachment zone may be in a lower and/or upper part of the outer casing, on at least one lateral wall of the latter.

The outer casing may include at least one polymer material, in particular containing polypropylene (PP), in particular in the form of a woven material, for example made of PP canvas. It advantageously has mechanical strength properties to resist tearing. It may include zones thicker than others or include reinforcements, in such a manner as locally to reinforce the mechanical strength properties. In particular, it may include reinforcements at the level of the edges of the front and rear walls, made essentially of PP for example. It may have a specific weight between approximately 190 g/m² and 300 g/m² inclusive, in particular between 200 g/m² and 270 g/m² inclusive, as a function of the dimensions of the outer casing. The outer casing preferably has a parallelepipedal shape. The tensile strength, measured in accordance with the ASTM D638 standard, in the warp direction may be between approximately 180 kgf and 240 kgf inclusive, that is to say approximately 1765 N and 2355 N. The tensile strength measured in accordance with the ASTM D638 standard in the weft direction may be between approximately 170 kgf and 240 kgf inclusive, that is to say between approximately 1665 N and 2355 N. The elongation measured in accordance with the ASTM D638 standard may be between approximately 18 and 20% approximately inclusive, in the warp or weft direction.

The inner casing may include at least one polymer material, in particular including polyethylene (PE), in particular a PE film or PE textile. It is advantageously impermeable to dust, to emissive and/or powder materials, to air and to water. The inner casing preferably has walls substantially parallel to the respective walls of the outer casing, in the immediate vicinity of the latter, within the container and in particular include a front wall, a rear wall, a lower wall, an upper wall and two lateral walls disposed longitudinally. These various walls together define the interior volume of the inner casing, corresponding to the interior volume of the container. The inner casing preferably has a parallelepipedal shape. The thickness of the walls of the inner casing may be between approximately 200 μm and 400 μm inclusive, in particular between 200 μm and 350 μm inclusive. An expanded PE layer may be attached, in particular adhesively bonded, to the inner surface at the level of the lower wall of the inner casing.

When present, the flap or flaps may be made of polymer material, in particular of PE film, with a thickness that may be between approximately 100 μm and 160 μm inclusive.

The interior volume of the container, in particular of the inner casing, may be greater than or equal to 3 m³, in particular 5 m³, in particular 10 m³, in particular 16 m³, or even 18 m³, in particular 24 m³, or even 35 m³.

The interior volume of the container is defined by that of the inner casing. The latter may include zones thicker than others in such a manner as locally to reinforce the mechanical strength properties because the waste may move with some force inside the volumes formed between the straps.

The outer casing may be connected to the inner casing by at least partial gluing, in particular total gluing between the lower, lateral, front and rear walls of the casings, which connection may be made by means of the flap or flaps when present at the location of the connection.

The opening of the inner casing may occupy a large part of the upper wall of the inner casing and have three edges, two longitudinal edges and a third edge of which connect them in the vicinity of the front or rear wall of the inner casing, substantially parallel to the latter. The three edges of the opening are preferably provided with meshing teeth to enable zip (or rack) closure of the opening.

Likewise, the opening of the outer casing may occupy a large part of the upper wall of the outer casing and have three edges, two longitudinal edges and a third edge of which connecting them in the vicinity of the rear or front wall of the outer casing, substantially parallel to the latter. It is to be noted that the opening of the outer casing preferably includes, as well as the two longitudinal edges, a third edge that is at the opposite end to that of the inner opening. Thus if the opening of the inner casing includes a third edge in the vicinity of the front wall, the opening of the outer casing preferably includes a third edge in the vicinity of the rear wall. The three edges of the opening of the outer casing are preferably provided with meshing teeth to enable zip (or rack) closure of the opening.

However, the present invention is not limited to any particular type of closure system and other closure systems may be envisaged without departing from the scope of the invention.

The inner casing may be provided, on its inner surface, in particular of the lateral wall or walls, with a plurality of anchor points for stretchers or elastic cables. Those elastic cables can make it possible to fasten the container to a metal skip in which the container will be disposed, with the openings of the outer and inner casings in the open position, in order to facilitate loading the container with waste.

A further object of the invention, in accordance with another aspect, in combination with the foregoing, is a method for packaging waste including the following steps:
disposing a flexible container as defined above in a metal skip,
opening the container by opening the outer casing and the inner casing,
depositing the waste in the interior volume of the container,
closing the container in sealed manner by closing the inner casing by means of the closure system and then closing the outer casing.

When the container includes one or more flaps, the final step includes attaching the flap or flaps by means of attachment means in the second attachment zone between the step of the closing the inner casing and that of the closing the outer casing.

### BRIEF DESCRIPTION OF THE FIGURES

The invention can be better understood on reading the following detailed description of nonlimiting embodiments thereof and examining the appended drawings, in which:

FIG. 1 is a schematic perspective view of an example of a closed outer casing of a container in accordance with the invention,

FIG. 2 is a schematic perspective view of an example of a closed inner casing of a container in accordance with the invention,

FIG. 3 is a schematic view from above of the casing from FIG. 2, closed,

FIG. 4 is a schematic view from the front of the casing from FIG. 2,

FIG. 5 is a schematic side view of the casing from FIG. 2,

FIG. 6 is a schematic view in isolation of a flap of a large lateral wall of the casing from FIG. 2,

FIG. 7 is a schematic view in isolation of a flap of a small lateral wall of the casing from FIG. 2,

FIG. 8 is a schematic view of an example of a container in accordance with the invention, closed, comprising the outer casing from FIG. 1 and the inner casing from FIG. 2,

FIG. 9 is a schematic partial view from above of an example of an inner casing of a container in accordance with the invention,

FIG. 10 is a schematic partial view in cross section of an example of an inner casing of a container in accordance with the invention,

FIG. 11 is a view similar to FIG. 3 of another example of an inner casing of a container in accordance with the invention, and

FIGS. 12 and 13 are schematic partial views in cross section of other examples of an inner casing of a container in accordance with the invention.

### DETAILED DESCRIPTION OF EMBODIMENTS OF THE INVENTION

In the remainder of the description, elements that are identical or have identical functions bear the same reference sign. For conciseness of the present description, they are not described with reference to all of the figures, only the differences between the embodiments being described.

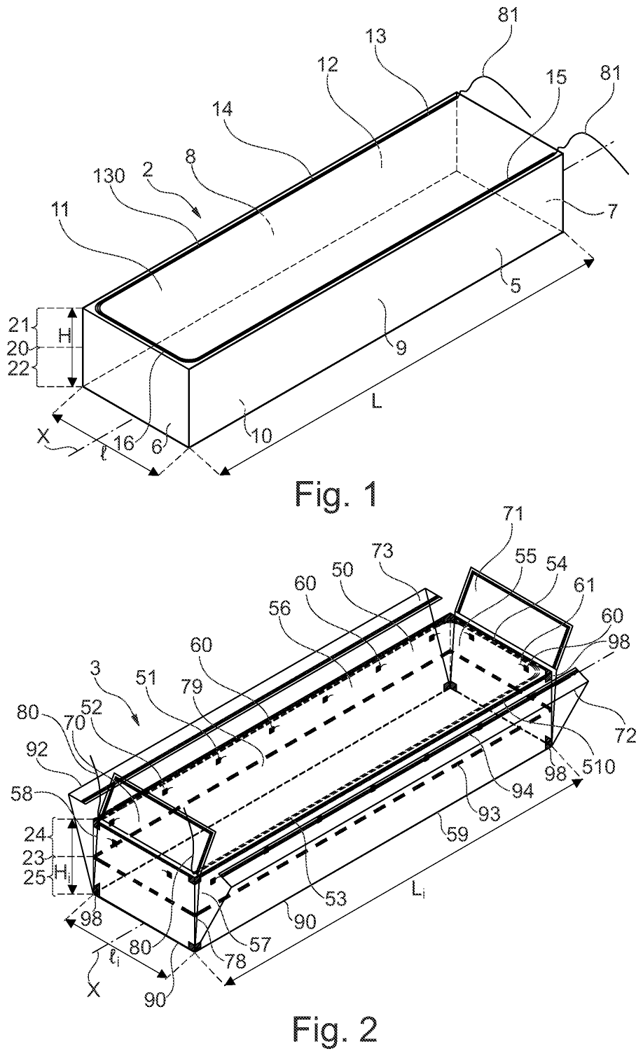

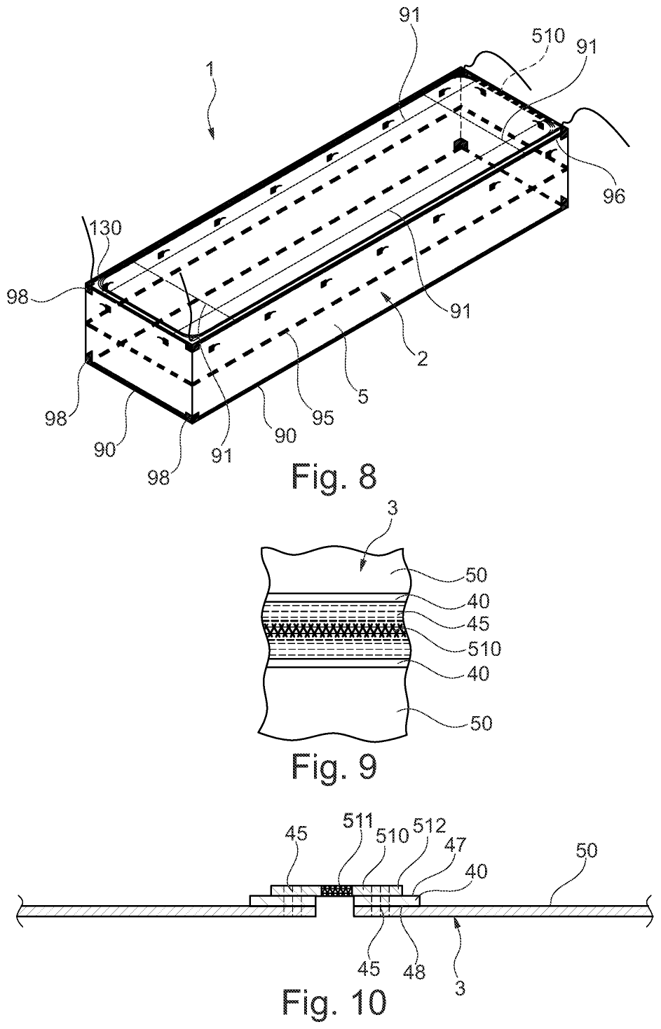

There has been represented in FIG. 1 an outer casing 2 of a container 1 illustrated in FIG. 8. The outer casing 2 defines an outer surface 5 of the container 1. It can be seen that it has an elongate shape along a longitudinal axis X.

In the example illustrated, the outer casing 2 has a parallelepipedal shape with a lower wall 10 and an upper wall 11 interconnected by four lateral walls, namely a front lateral wall 6, a rear lateral wall 7, two side lateral walls 8 and 9. The lower wall 10 and the upper wall 11 are separated from one another by the lateral walls 8 and 9. The lateral walls 6, 7, 8 and 9 define the total height H of the outer casing 2 and therefore of the container 1, equal to 1.6 m in this example. The length L of the outer casing 2, that is to say the length of each lateral wall 8 or 9, is 8.8 m in this example. The width/of the outer casing 2 corresponding to the width of the front lateral wall 6 or the rear lateral wall 7 is 2.5 m. The outer casing 2 has an inner surface 12.

An upper part 21 of the outer casing 2 and a lower part 22 of the outer casing 2 are defined by means of a virtual line 20 disposed at mid-height of the lateral walls 5, 6, 7 and 8 of the outer casing 2. The central portion of the outer casing 2 is located approximately at the level of or around the line 20. The upper part 21 includes the upper wall 11 of the outer casing 2. The lower part 22 includes the lower wall 10 of the outer casing 2.

The upper wall 11 is occupied over a great part of its surface by an opening 13 defined by three edges, namely two longitudinal edges 14 and 15 parallel to the longitudinal axis X and a front edge 16 joining them, in the vicinity of the front lateral wall 6 in this example, perpendicularly to the longitudinal axis X. The opening 13 can be opened or closed by means of a closure system 130 along the longitudinal edges 14 and 15 and the front edge 16. The closure system 130 of the outer casing 2 includes a zip in this example. Cords 81 of sufficient length are provided to enable an operative to actuate the closure system 130 from the bottom of the container or to facilitate that actuation. The outer casing 2 is made of woven polymer material, in particular of PP canvas. In this example the weight of the outer casing 2 is approximately 270 g/m². The outer casing 2 is mechanically strong.

There has been represented in FIG. 2 an inner casing 3 of the container 1 in accordance with the invention. The inner casing 3 is intended to be disposed inside the outer casing 2 inside the container 1. It delimits an interior volume V of the container for accommodating waste.

The inner casing 3 is made of polymer material, in particular of polyethylene, in particular of a material impermeable to dust. The inner casing 3 is made of a PE film in this example having a thickness of approximately 350 μm.

The inner casing 3 has a parallelepipedal shape similar to that of the outer casing 2. The inner casing 3 includes a lower wall 59 and an upper wall 50 and four lateral walls connecting the lower wall 59 and the upper wall 50, namely a front lateral wall 58, a rear lateral wall 55, two side lateral walls 56 and 57. The inner casing 3 has an outer surface 78 and an inner surface 79. The outer surface 78 of the inner casing 3 faces the inner surface 12 of the outer casing 2. The inner casing 3 is disposed in the outer casing 2 in such a manner that the front lateral wall 58 is alongside the front lateral wall 6 and the rear lateral wall 55 is alongside the rear lateral wall 7. The dimensions of the inner casing 3 are identical in this example to those of the outer casing 2, with a total height H a width lᵢ and a length Lᵢ, where Hᵢ=H, lᵢ=l and Lᵢ=L in this example. They may be different, in particular smaller, without departing from the scope of the invention.

An upper part 24 of the inner casing 3 and a lower part 25 of the inner casing 3 are defined by means of a virtual line 23 disposed at mid-height of the lateral walls 55, 56, 57 and 58 of the inner casing 3. The central portion of the inner casing 3 is approximately at the level of or around the line 23. The upper part 24 includes the upper wall 50 of the inner casing 3. The lower part 25 includes the lower wall 59 of the inner casing 3.

The upper wall 50 is provided with an opening 51 for the introduction of waste, defined by three edges in this example, including two longitudinal edges 52 and 53 parallel to the longitudinal axis X. It includes a third, rear edge 54 connecting the edges 52 and 53 and extending in the vicinity of the rear wall 55. The opening 51 is substantially superposed on the opening 13 of the outer casing 2 inside the container 1. The opening 51 can be opened or closed by means of a closure system 510 disposed along the longitudinal edges 52 and 53 and the rear edge 54. In this example the closure system 510 of the inner casing 3 includes a zip closure, with a zip 511 and a polyester textile strip 512 to which the zip 511 is sewn. Cords 80 of sufficient length are also provided to enable an operative to actuate the closure system 510 from the bottom of the container or to facilitate that actuation.

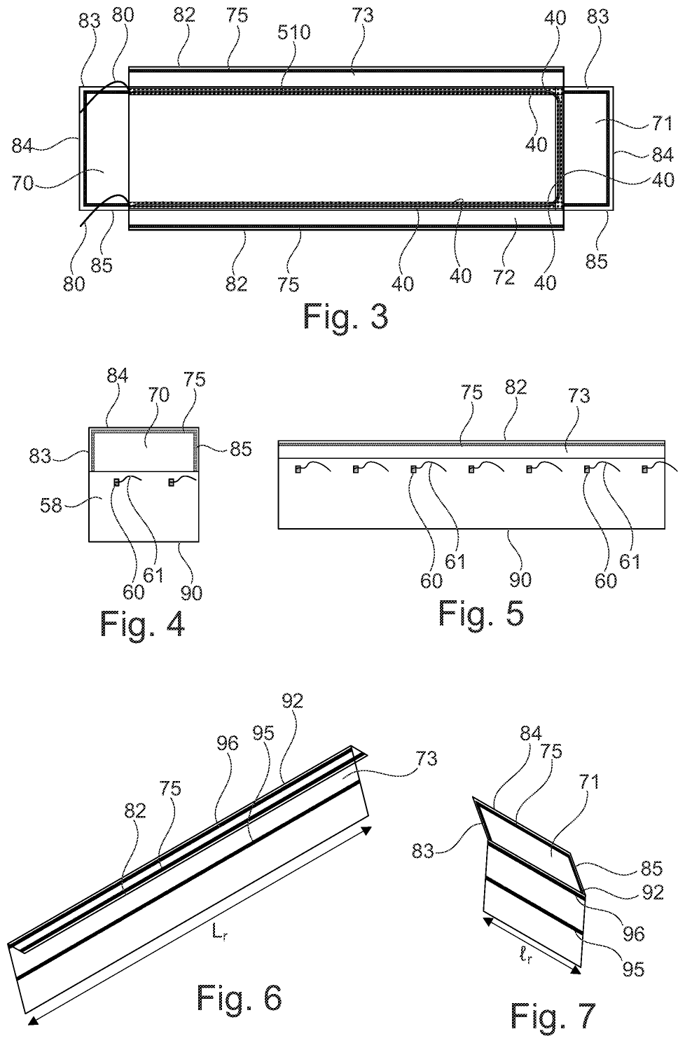

The container 1 includes at least one reinforcing strip 40, in the example illustrated a plurality of reinforcing strips 40 that can be seen in FIG. 3, disposed on either side of the closure system 510. As can be seen in more detail in FIGS. 9 and 10, the upper wall 50 of the inner casing 3 is sewn by means of stitches 45, in the form of three rows of stitches in this example, to the closure system 510 on either side of the corresponding edge of the opening 51. Between the upper wall 50 and the closure system 510 is interleaved a reinforcing strip 40 attached to each of them by the same stitches 45. The reinforcing strips 40 are made of glassfiber-reinforced polyethylene terephthalate (PET) film. The presence of these reinforcing strips 40 enables the strength of the inner casing 3 to be reinforced, especially at the level of the stitches 45 which may weaken the inner casing 3. At least one of the faces 47, or even both faces 47 and 48, of the reinforcing strip or strips 40 is coated with an adhesive, for example a synthetic rubber resin.

It has been calculated that the strength at the level of the closure system 510 was enhanced by the presence of the reinforcing strip 40. With no reinforcing strip the tension force may be up to 10.6 kgf and the elongation may be up to 22%, whereas with the reinforcing strip, 19.4 kgf and an elongation of 81% can be achieved.

The inner casing 3 is also provided in this example with a plurality of anchor points 60 for elastic cables 61 or stretchers that can be seen in FIGS. 2, 4 and 5. The anchor points 60 are attached all around the perimeter of the inner surface 79 of the inner casing 3, that is to say all four of the front lateral wall 58, rear lateral wall 55 and side lateral walls 56 and 57. The elastic cables 61 may be removably attached, in the open position of the container 1, to fixing points present on a metal skip accommodating the container 1 when loading waste.

The inner casing 3 includes reinforcing parts 98 disposed at each of its corners, as can be seen in FIGS. 2 and 8 in particular, on its interior surface and/or its exterior surface, attached by welding for example.

The open position of the container 1 corresponds to the simultaneous open positions of the opening 13 and of the opening 51. The closed position of the container 1 corresponds to the simultaneous closed positions of the opening 13 and of the opening 51. It is to be noted that the edge 16 of the opening 13 is situated opposite the edge 54 of the opening 51, the first being on the same side as the front wall 6 while the second is on the same side as the rear wall 55. The opening 13 opens on the same side as the rear part 7 while the opening 51 opens on the same side as the front part 58.

The container 1 includes at least one flap, in this example a plurality of flaps, made for example of PE film, four in number in this example, namely a rear flap 70, a front flap 71 disposed at the opposite end, and also two lateral flaps 72 and 73.

The rear flap 70 and the front flap 71 are identical to one another. The flap 71 is represented on its own in FIG. 7. The lateral flaps 72 and 73 are identical to one another. The flap 73 is represented on its own in FIG. 6. The flaps 70 and 71 are of width lᵣ equal to the width lᵢ of the inner casing 3. The flaps 72 and 73 are of width Lᵣ equal to the length Lᵢ of the inner casing 3. The flaps 70, 71, 72 and 73 are attached by welding in a first attachment zone 90 of the container 1 formed in this example at the junction between the lower wall 59 of the inner casing 3 and the respective lateral walls 58, 55, 57 and 56. The weld is advantageously formed continuously over all the length or the width of the inner casing 3 corresponding to this junction forming an edge. The flaps 70, 71, 72 and 73 thus cover the respective lateral walls 58, 55, 57 and 56 entirely, over all the height H, in this example. The container 1 thus includes laterally triple layers formed by the lateral walls of the inner casing 3 and the outer casing 2 between which the respective flaps 70, 71, 72 and 73 are interleaved.

The container 1 includes a second attachment zone 91, visible in dashed line in FIG. 8, disposed on the other side of the closure system 510 relative to the first attachment zone 90. The flaps 70, 71, 72 and 73 each include attachment means 75 consisting in this example of an adhesive, in particular a double-sided adhesive tape for attaching them to the inner casing 3 in the second attachment zone 91. These attachment means 75 are disposed, as can be seen in FIGS. 6 and 7, along at least one edge of the flap, parallel to the latter. In FIG. 6 it is seen that the attachment means 75 are in the form of a parallel strip near the edge 82 of the flap 73. In FIG. 7 it is seen that the attachment means 75 are in the form of three strips parallel to the three edges 83, 84 and 85 of the flap 71. The edges of the flaps provided with attachment means 75 can also be seen in FIGS. 3, 4 and 5.

The flaps 70, 71, 72 and 73 cover the closure system 510 entirely, creating a seal at the level of the closure of the inner casing 3. In this example the first attachment zone 90 is on the lateral walls 58, 55, 57 and 56 of the inner casing 3 and the second attachment zone 91 is on the upper wall 50 of the inner casing 3. The flaps 70, 71, 72 and 73 are provided with a fold 92 formed in such a manner as to come to cover the folded junction, forming an edge, between the lateral walls 58, 55, 57 and 56 and the upper wall 50, in order to espouse as closely as possible the lines of the inner casing 3.

Still in the example illustrated, the container 1 further includes a third attachment zone 93 and a fourth attachment zone 94 for attaching each flap 70, 71, 72 and 73 to the corresponding lateral wall 58, 55, 57 and 56 of the inner casing 3. The attachment zones 93 and 94 are respectively in a central portion and in an upper portion of each lateral wall 58, 55, 57 and 56. Double-sided adhesive tapes 95 and 96, visible in FIGS. 6 and 7, and also in dashed line in FIG. 2, are respectively disposed on the flaps and/or on the inner casing 3 to enable attachment between the flap and the corresponding lateral wall, respectively at the levels of the third attachment zone 93 and of the fourth attachment zone 94.

In this example the flaps are made of polymer material, in particular of polyethylene film, reinforced or not, having a thickness that may be between 100 μm and 160 μm inclusive.

The flaps may also be attached to the outer casing 2, in particular by adhesive tape, for example in attachment zones situated on a lower part and on an upper part of the lateral walls 6, 7, 8 and 9 of the outer casing 2.

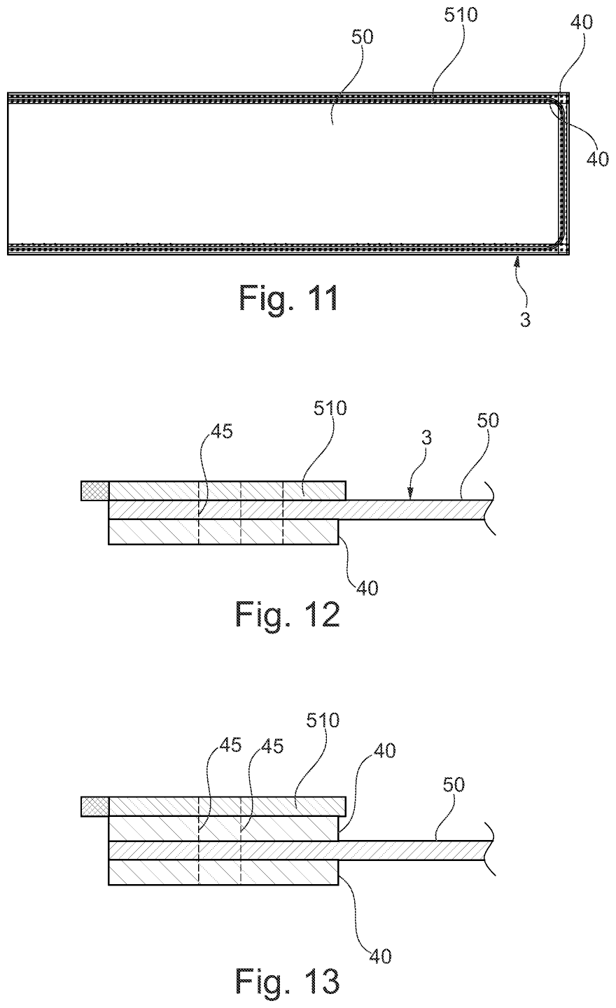

The invention is not limited to the examples that have just been described. In particular, a container having no flaps is still within the scope of the invention. There has been represented in FIG. 11 the inner casing 3 of a container 1 in accordance with the invention that has no flaps. Flaps covering only a part of the height of the lateral walls of the inner casing 3 also do not depart from the scope of the invention.

The reinforcing strip 40 may be disposed under the inner casing 3, as illustrated in FIG. 12. In accordance with this example, there is a stack comprising the closure system 510, the inner casing 3 and finally, under the latter, the reinforcing strip 40.

Again there may be two superposed reinforcing strips, as illustrated in FIG. 13 for example, with a reinforcing strip 40 interleaved between the closure system 510 and the inner casing 3 and another reinforcing strip 40 under the inner casing 3. In this example also the interleaved reinforcing strip 40 does not project from the closure system 510.

At least two reinforcing strips 40 may be disposed one against the other.

The inner and outer casings may have some other shape, for example a cylindrical shape with a single circular lateral wall, or other shape.

1. A flexible container for packaging waste, including:
an outer casing forming the outer surface of the container and having, in a top part, an opening that can be opened or closed,
an inner casing delimiting an inner space of the container for receiving and accommodating the waste, disposed inside the outer casing, the inner casing including, in a top part, an opening that can be opened or closed by means of a closure system attached to the inner casing, and
at least one reinforcing strip superposed at least partially on and attached to the closure system and to the inner casing.

2. The container as claimed in claim 1, wherein said at least one reinforcing strip is interleaved between the closure system and the inner casing.

3. The container as claimed in claim 1, wherein the closure system includes a zip.

4. The container as claimed in claim 1, wherein the closure system is fixed by sewing to the inner casing.

5. The container as claimed in claim 1, wherein said at least one reinforcing strip includes a composite material with a fiber reinforcement comprising fibers chosen in the group consisting of glass fibers, carbon fibers, aramide fibers, natural fibers and mixtures thereof.

6. The container as claimed in claim 5, wherein the fiber reinforcement is woven.

7. The container as claimed in claim 5, wherein said at least one reinforcing strip includes at least one polymer chosen in the group consisting of a polyolefin, polyethylene terephthalate, polyester.

8. The container as claimed in claim 1, wherein said at least one reinforcing strip is covered on one of its faces or on both its faces with an adhesive.

9. The container as claimed in claim 3, wherein the outer casing includes a zip, the zips of the inner casing and of the outer casing having oppositely oriented U-shaped profiles.

10. The container as claimed in claim 1, including at least one flap interleaved between the outer casing and the inner casing (3), the container including at least one first attachment zone and one second attachment zone disposed on respective opposite sides of the closure system, the flap or flaps being attached to the inner casing in at least the first attachment zone, the flap or flaps and/or the inner casing being provided with attachment means to be able to attach the flap or flaps to the inner casing in the second attachment zone after closure of the inner casing.

11. The container as claimed in claim 10, wherein the first attachment zone is situated in the lower part of the inner casing, the flap or flaps being welded to the inner casing in this first attachment zone.

12. The container as claimed in claim 10, wherein the inner casing includes an upper wall, the second attachment zone being on the upper wall of the inner casing, the attachment means in this second attachment zone including an adhesive.

13. The container as claimed in claim 10, wherein the inner casing includes a lower wall and at least one lateral wall, the first attachment zone being in a lower portion of said at least one lateral wall, the flap or flaps then covering the total height (Hᵢ) of the lateral wall or walls.

14. The container as claimed in claim 1, wherein the inner casing has a substantially parallelepipedal shape, the inner casing including four lateral walls, the container including four flaps covering the lateral walls at least partly.
